(19) United States
(12) Patent Application Publication
(10) Pub. No.: US 2010/0049434 A1
(43) Pub. Date: Feb. 25, 2010

(54) VEHICLE NAVIGATION SYSTEM HAVING SEPARATE CONTROL INTERFACE

(75) Inventor: XianZhong Liu, Shanghai City (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Appliances Corp.

(21) Appl. No.: 12/482,842

(22) Filed: Jun. 11, 2009

(30) Foreign Application Priority Data
Aug. 25, 2008 (TW) 097132389

(51) Int. Cl. G01C 21/36; H04L 9/00

(52) U.S. Cl. 701/209; 701/200; 345/173; 380/270

(57) ABSTRACT

A vehicle navigation system having a separate control interface is provided, which includes a control device arranged on a vehicle steering wheel and a navigation device disposed in the inner of the vehicle. The control device is wirelessly connected with the navigation device, and has an input module for inputting a control command and a confirmation command. After obtaining the control command, the navigation device uses a build-in speaker to make a confirmation voice. A user determines whether the control command is correct or not and then input a confirmation command accordingly. The navigation device decides whether to execute a path navigation operation according to the control command when obtaining the confirmation command. In the system, the user carries on the navigation operation or switches associated settings of the navigation device without leaving hold of the steering wheel.

### CROSS-REFERENCE TO RELATED APPLICATION

This application claims the benefit of Taiwan Patent Application No. 097132389, filed on Aug. 25, 2008, which is hereby incorporated by reference for all purposes as if fully set forth herein.

### BACKGROUND OF THE INVENTION

1. Field of Invention

The present invention relates to a navigation system, and more particularly to a vehicle navigation system having a separate control interface, in which the control interface is arranged on a vehicle steering wheel and wirelessly controls a navigation device.

2. Related Art

In prior art, a navigation device is an integrated electronic device, which has a control interface of various different aspects, such as a display, buttons, a touchpad, or touch screen. The navigation device is mostly arranged in the middle of a driving table, above a sound arrangement, and is at user's elbow to be conveniently used by the user. Therefore, the driver can select a function or input a path instruction through the control interface by pressing the buttons or utilizing a touch manner to input the related texts such as addresses and scenes, so as to carry on a path navigation operation. Also, the control interface can be used to perform other additional build-in functions, for example, playing the multimedia data (music, images, and photos), weather forecast, etc., so as to meet the driver's need and achieve the purpose of carrying on the navigation operation while driving.

However, the prior art has the following unavoidable disadvantages.

Firstly, it should be avoided for a driver to pay less attention on the road condition and leave their hand away from the steering wheel. However, there is a need for the driver to leave one hand away to perform the operation of pressing, touching the buttons, touchpad or touch screen on the control interface in order to control the navigation device. Therefore, the drivers may loss their car control and increase the danger possibility during their driving.

Secondly, the driver needs to watch the display or the touch screen of the navigation device if he/she wants to alter the setting of the navigation device, thus resulting in less attention to the front of the vehicle and increasing the danger of the driving.

### SUMMARY OF THE INVENTION

In this regard, the present invention is directed to a navigation system, which makes a driver still maintain the control of a vehicle when changing a setting of a navigation device and keeps paying attention to the road condition.

Accordingly, the present invention provides a vehicle navigation system having a separate control interface. The system comprises a control device and a navigation device. The control device is arranged on a vehicle steering wheel, and the navigation device is disposed in the inner of the vehicle.

The control device includes an input module and a wireless transmitting module, and the navigation device includes a wireless receiving module, a navigation module, and a speaker. The input module is capable of inputting a control command and a confirmation command. The wireless transmitting module is capable of outputting the control command, and output the confirmation command to the wireless receiving module. The navigation module outputs a confirmation voice by the speaker when obtaining the control command through the wireless receiving module, and determines whether to execute a path navigation according to the control command when obtaining the confirmation command.

The present invention may have the following effects superior to the prior art.

Firstly, as the control device is arranged on the vehicle steering wheel, the driver's hands can be within the range covered by the steering wheel and can get hold of the steering wheel as soon as possible, thus maintaining the control of the vehicle and increasing the security of the driving.

Secondly, when obtaining the control command, the navigation device outputs the confirmation voice to prompt the driver the input control command, so the driver need not call off attention, thus keeping paying attention to the front of the vehicle and increasing the security of the driving.

### BRIEF DESCRIPTION OF THE DRAWINGS

FIG. 1 is a schematic view of system architecture according to an embodiment of the present invention;

FIG. 2A is a schematic view of an arrangement of a keypad according to a first embodiment of the present invention;

FIG. 2B is a partial schematic view of a portion 2B shown in FIG. 2A;

FIG. 3A is a schematic view of an arrangement of a voice input module according to a second embodiment of the present invention;

FIG. 3B is a partial schematic view of a portion 3B shown in FIG. 3A;

FIG. 4A is a schematic view of an arrangement of a touch screen according to a third embodiment of the present invention;

FIG. 4B is a partial schematic view of a portion 4B shown in FIG. 4A;

FIG. 5A is a schematic view of an arrangement of a touchpad according to a fourth embodiment of the present invention;

FIG. 5B is a partial schematic view of a portion 5B shown in FIG. 5A;

FIG. 6A is a schematic view of an arrangement of hot keys according to a fifth embodiment of the present invention;

FIG. 6B is a partial schematic view of a portion 6B shown in FIG. 6A; and

FIG. 7 is a schematic view of a screen arrangement of a navigation device according to an embodiment of the present invention.

### DETAILED DESCRIPTION OF THE INVENTION

The purposes, structural features and functions of the invention will be further appreciated by reference to the following detailed illustration of the relevant embodiments and drawings.

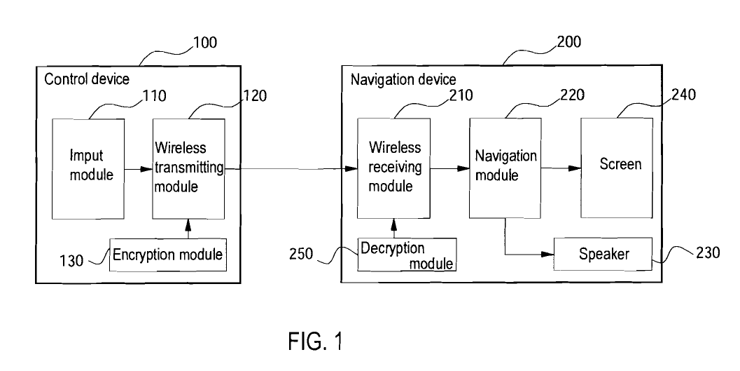

Referring to FIG. 1, a schematic view of system architecture according to an embodiment of the present invention is shown. The system includes a control device 100 and a navigation device 200. The control device 100 is arranged on a steering wheel 310 of a vehicle, and the navigation device 200 is disposed in the inner of the vehicle.

The control device 100 includes an input module 110 and a wireless transmitting module 120, and the navigation device 200 comprises a wireless receiving module 210, a navigation module 220, and a speaker 230. A driver uses the input module 110 to input a control command, which is transmitted to the wireless receiving module 210 through the wireless transmitting module 120 and then transmitted to the navigation module 220 by the wireless receiving module 210. The navigation module 220 first analyzes a requirement in the control command, and then makes a confirmation voice corresponding to the control command by the speaker 230 to prompt the driver the input control command and inquire whether the control command is correct and whether to perform the control command. Thereafter, the driver uses the input module 110 to input a confirmation command, which is wirelessly transmitted to the navigation module 220 through the wireless transmitting module 120 and the wireless receiving module 210. When the navigation module 220 determines the confirmation command as that the control command is correct, the navigation module 220 performs a path navigation according to the control command. When the navigation module 220 determines confirmation command as that the control command is not correct, the navigation module 220 cancels the control command.

The wireless transmitting module 120 can be an infrared transmitting module, and the wireless receiving module 210 can be an infrared receiving module. Alternatively, both the wireless transmitting module 120 and the wireless receiving module 210 are bluetooth modules.

The control device 100 is arranged with an encryption module 130, which is configured to encrypt the control command and transmit the encrypted control command to the navigation device 200 through the wireless transmitting module 120. The navigation device 200 is arranged with a decryption module 250, which is configured to decrypt the control command received by the wireless receiving module 210 to be further analyzed by the navigation module 220.

The navigation device 200 is arranged with a screen 240, which is configured to display a confirmation text 241, a confirmation drawing 242, or a combination of the confirmation text 241 and the confirmation drawing 242 corresponding to the control command when the navigation module 220 uses the speaker 230 to make the confirmation voice.

The navigation module 220 may be a satellite navigation module 220, which stores at least one map data therein. The satellite navigation module 220 receives a satellite positioning signal to obtain a coordinate data corresponding to the map data, thereby displaying the coordinate data in combination with the map data on the screen 240.

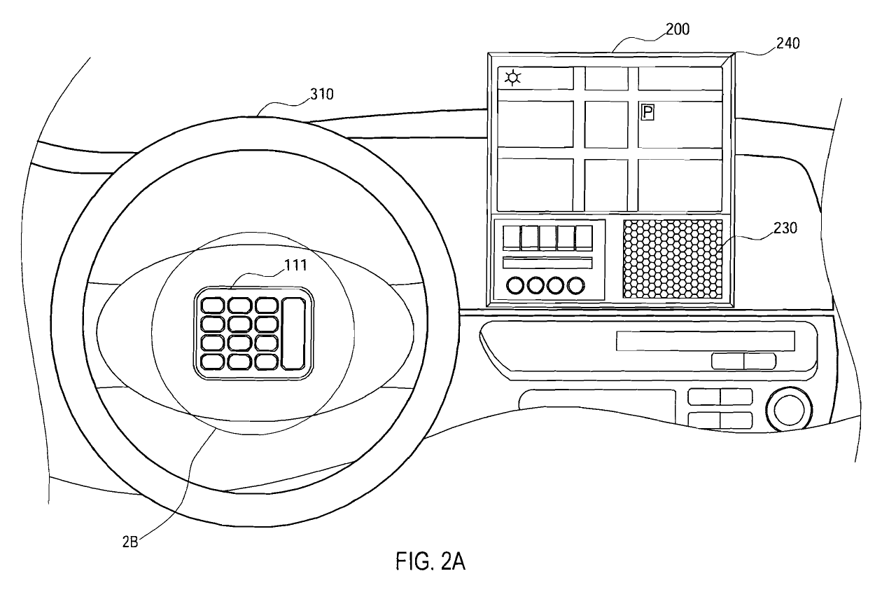

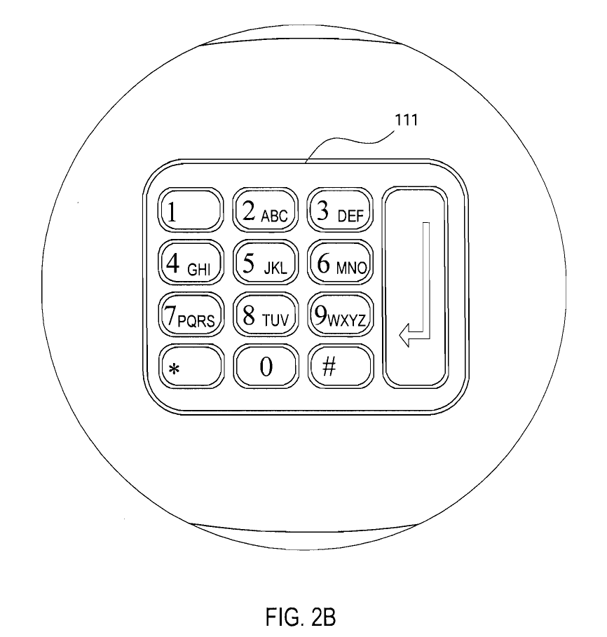

Referring to FIGS. 2A and 2B, a schematic view of arrangement of a keypad 111 according to a first embodiment of the present invention and a partial enlarged schematic view thereof are shown respectively, and better understanding may be obtained together with reference to FIG. 1. In this embodiment, the input module 110 is a keypad 111, which has a plurality of buttons each corresponding to a numeral and a letter (e.g., phonetic symbol) of the input method or a specific function and pressed to input a text and numeral or activate a function to form the control command.

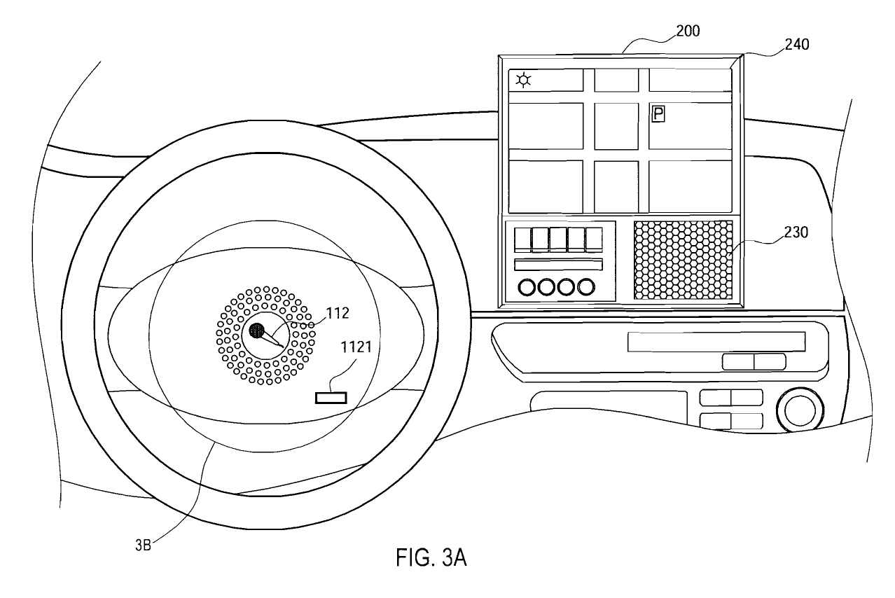

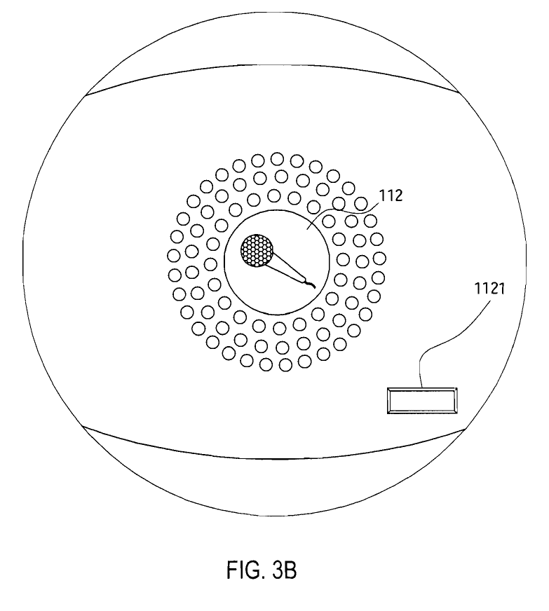

Referring to FIGS. 3A and 3B, a schematic view of arrangement of a voice input module 112 according to a second embodiment of the present invention and a partial enlarged schematic view thereof are shown respectively, and better understanding may be obtained together with reference to FIG. 1. In this embodiment, the input module 110 is a voice input module 112 (e.g., microphone), which is used to receive a sound signal made by the driver and convert the sound signal into the control command to achieve an acoustic control effect. The voice input module 112 can be arranged with a switch 1121, which is configured to control the activation or deactivation of the voice input module 112 to avoid obtaining incorrect control commands by the navigation device 200.

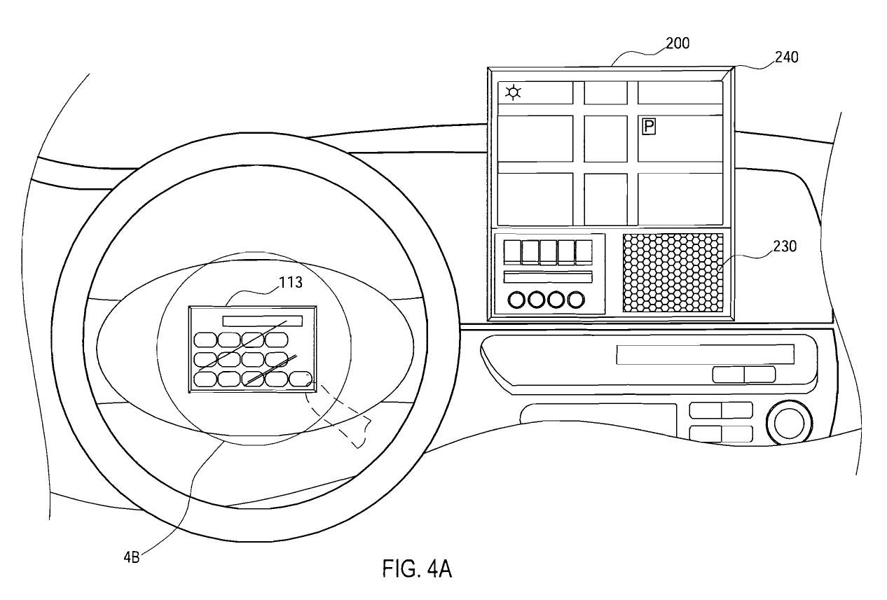

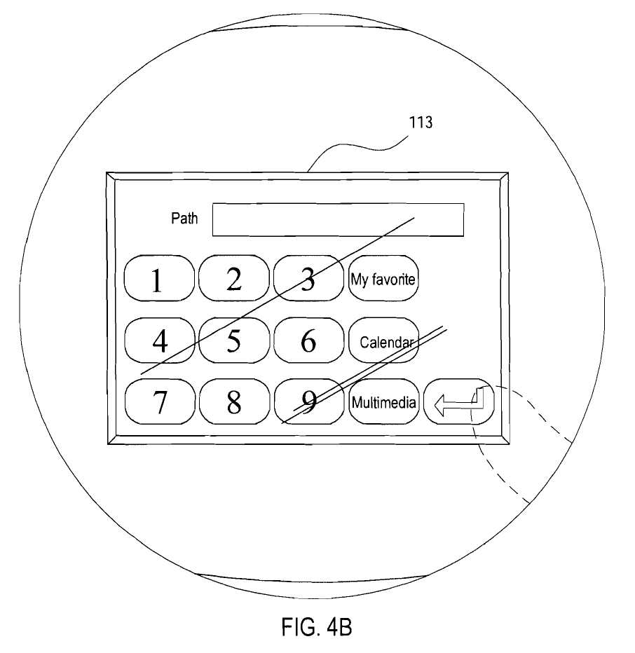

Referring to FIGS. 4A and 4B, a schematic view of arrangement of a touch screen 113 according to a third embodiment of the present invention and a partial enlarged schematic view thereof are shown respectively, and better understanding may be obtained together with reference to FIG. 1. In this embodiment, the input module 110 is a touch screen 113, which displays a plurality of functional modules (e.g., the graphical buttons and textual buttons) for touching, and forms the required control command according to the touched functional module when being touched by the driver.

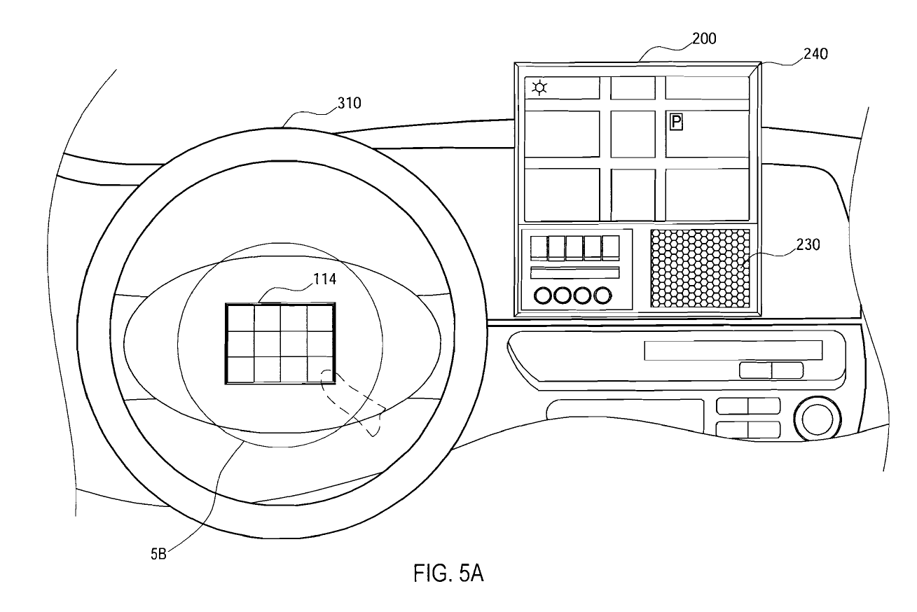

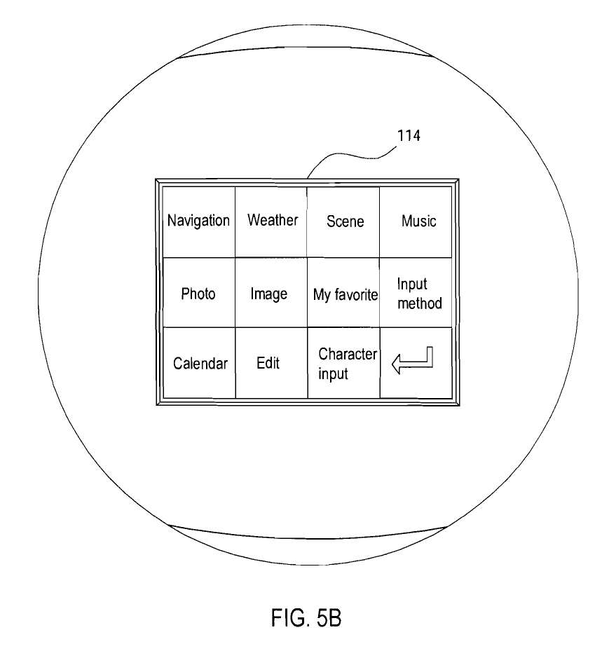

Referring to FIGS. 5A and 5B, a schematic view of arrangement of a touchpad 114 according to a fourth embodiment of the present invention and a partial enlarged schematic view thereof are shown respectively, and better understanding may be obtained together with reference to FIG. 1. In this embodiment, the input module 110 is a touchpad 114, which is prearranged with a fixed function drawing, a function text or a combination of the drawing and the text.

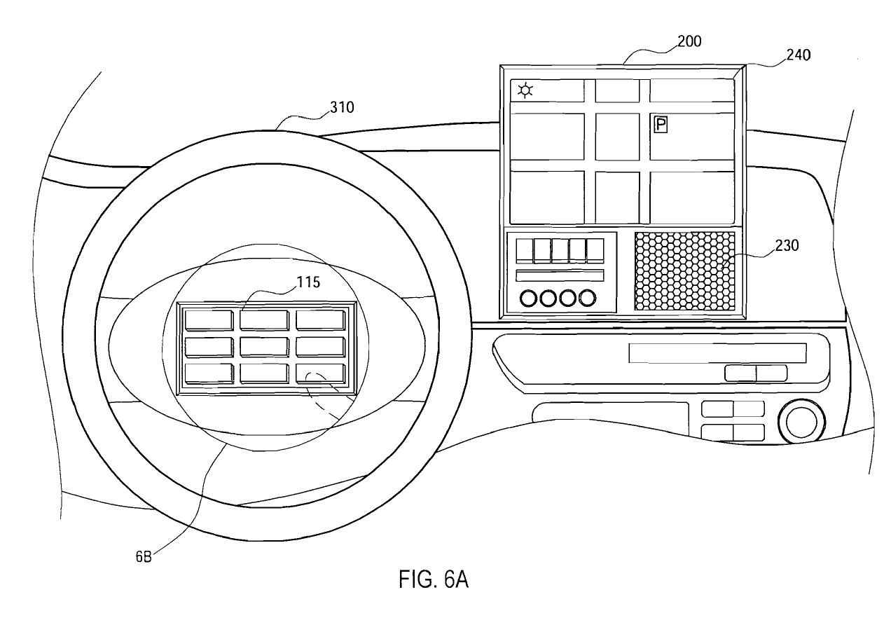

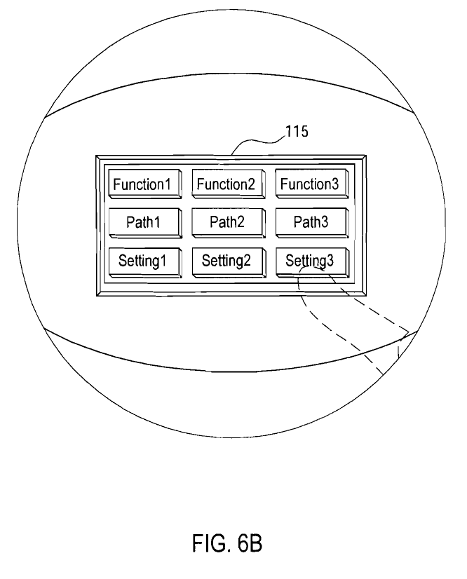

Referring to FIGS. 6A and 6B, a schematic view of arrangement of hot keys according to a fifth embodiment of the present invention and a partial enlarged schematic view thereof are shown respectively. The input module 110 is a hot keypad 115, which is consist of a keypad and a memory module (not shown). The hot keypad 115 has a plurality of buttons, and the memory module records a plurality of handy instructions corresponding to the buttons one by one. When the driver presses anyone of the buttons, the input module 110 extracts the handy instruction corresponding to the button to form the control command.

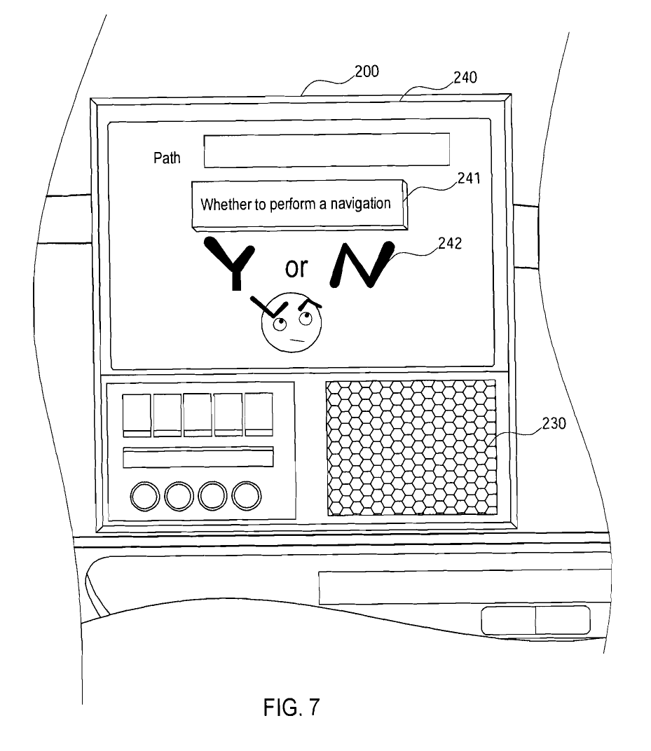

Referring to FIG. 7, a schematic view of an arrangement of a screen 240 of the navigation device 200 according to an embodiment of the present invention is shown, and better understanding may be obtained together with reference to FIG. 1. The navigation device 200 is arranged with a screen 240, which is used to display the confirmation text 241, the confirmation drawing 242, or the combination of the confirmation text 241 and the confirmation drawing 242 corresponding to the control command by the navigation module 220, when the navigation module 220 uses the speaker 230 to make the confirmation voice.

While the present invention has been described with reference to the foregoing preferred embodiments but is not limited thereto, it will be appreciated by those skilled in the art that various modifications and adaptations may be made without departing from the spirit and scope of the present invention, the scope of which is defined by the appended claims.

What is claimed is:

1. A vehicle navigation system having a separate control interface, comprising:
a control device, arranged on a vehicle steering wheel and including an input module and a wireless transmitting module, wherein the input module is capable of inputting a control command and a confirmation command, and the wireless transmitting module is capable of outputting the control command and the confirmation command; and
a navigation device, disposed in the inner of the vehicle and including a wireless receiving module, a navigation module and an speaker, wherein the wireless receiving module receives the control command to transmit the control command to the navigation module and receives the confirmation command to transmit the control command to the navigation module, and the navigation module outputs a confirmation voice by the speaker when obtaining the control command and determines whether to execute a path navigation according to the control command when obtaining the confirmation command.

2. The vehicle navigation system having a separate control interface according to claim 1, wherein the input module is a keypad, and the keypad has a plurality of buttons to be pressed to input the control command.

3. The vehicle navigation system having a separate control interface according to claim 1, wherein the input module is a voice input module, and the voice input module receives a sound signal and converts the sound signal into the control command.

4. The vehicle navigation system having a separate control interface according to claim 3, the voice input module further comprises a switch, which is configured to control the activation or deactivation of the voice input module.

5. The vehicle navigation system having a separate control interface according to claim 1, wherein the input module is a touch screen, and the touch screen displays a plurality of functional modules to be touched to form the control command.

6. The vehicle navigation system having a separate control interface according to claim 1, wherein the input module is a touchpad, and the touchpad is prearranged with fixed drawings or texts.

7. The vehicle navigation system having a separate control interface according to claim 1, wherein the input module comprises a keypad and a memory module, the memory module records a plurality of handy instructions, the keypad has a plurality of buttons, and the input module extracts the matched handy instruction to form the control command when one of the buttons is pressed.

8. The vehicle navigation system having a separate control interface according to claim 1, wherein the navigation device further comprises a screen, and the navigation module utilizes the screen to display a confirmation text corresponding to the control command.

9. The vehicle navigation system having a separate control interface according to claim 1, wherein the navigation device further comprises a screen, and the navigation module utilizes the screen to display a confirmation drawing corresponding to the control command.

10. The vehicle navigation system having a separate control interface according to claim 1, wherein the navigation module is a satellite navigation module, and the navigation module stores at least one map data therein and receives a satellite positioning signal to obtain a coordinate data corresponding to the map data, thereby displaying the coordinate data in combination with the map data.

11. The vehicle navigation system having a separate control interface according to claim 1, wherein the wireless transmitting module is an infrared transmitting module, and the wireless receiving module is an infrared receiving module.

12. The vehicle navigation system having a separate control interface according to claim 1, wherein both the wireless transmitting module and the wireless receiving module are bluetooth modules.

13. The vehicle navigation system having a separate control interface according to claim 1, the control device further comprises an encryption module, which is configured to encrypt the control command and transmit the encrypted control command to the navigation device through the wireless transmitting module.

14. The vehicle navigation system having a separate control interface according to claim 1, the navigation device further comprises a decryption module, which is configured to decrypt the control command received by the wireless receiving module to be further analyzed by the navigation module.
